(19) United States
(12) Patent Application Publication
(10) Pub. No.: US 2025/0026034 A1
(43) Pub. Date: Jan. 23, 2025

(54) BEARD TRIMMER WITH CUTTING UNIT DAMPING SYSTEM

(71) Applicant: BaByliss Faco srl, Wandre (BE)

(72) Inventor: Charles DE GOUZILLON DE BELIZAL, Hertstal (BE)

(21) Appl. No.: 18/713,902

(22) PCT Filed: Nov. 29, 2022
(86) PCT No.: PCT/EP2022/083580

§ 371 Date: May 28, 2024

(30) Foreign Application Priority Data
Dec. 20, 2021 (EP) 21215831.5

(51) Int. Cl. B26B 19/02

(52) U.S. Cl. CPC B26B 19/02

(57) ABSTRACT

A beard trimmer includes a handle having a motor, a cutting head having a fixed blade and a movable blade, and a cutting head suspension system. The suspension system includes a fixed-blade movable support connecting the fixed blade of the cutting head to the handle. The fixed-blade movable support is pivotably mounted on the handle and has a proximal portion located on the handle side and a distal portion located on the cutting-head side. An elastic means creates a return force that allows the fixed-blade movable support to return to its rest position and the pressure of the cutting head on the user's skin to be absorbed. The handle includes a hollow space to accommodate the proximal portion of the movable support, the proximal portion of the movable support being fully retractable into the hollow space in the handle when the elastic means is in the rest position.

### BACKGROUND

Beard trimmers comprise a handle and a motorized cutting head. The cutting head consists of a fixed blade and a movable blade and may also be equipped with a comb to adjust the desired cutting length. The user encounters many different curvatures on the face when trimming the beard, more particularly at the chin and near the nose, and the quality of the cut depends largely on the ease of use of the trimmer and on the visibility the user has on the blades during use. In general, the cutting head of the prior art trimmers is covered by a bulky casing that only reveals the toothed parts of the blades and does not allow the user to have a direct view of the blades during trimming.

Document WO2005122685 discloses a trimmer with a cutting head and a comb arranged on a handle so as to be simultaneously movable relative to the handle, while keeping a constant distance between the cutting unit and the comb to not affect the cutting length. Thereby, if too much pressure is applied to the skin, the cutting unit and the comb recede and reduce the pressure acting on the skin. However, because the distance between the comb and the cutting unit is kept constant while moving, the cut length remains unchanged. In a particular example of said document, the motor is also movable and set in motion along with the cutting unit and the comb. The motor is located in the handle and is connected to the cutting unit by a “motion converter”, which transmits the pressure on the cutting unit to the motor, the latter pushing on a spring provided in the handle to dampen the movements on the skin. This apparatus improves the user's experience during trimming and also reduces the friction on the skin due to strong pressure. However, the device has the drawback of comprising a set of movable parts external to the handle, arranged in a way that makes the trimmer cumbersome and difficult to handle, more particularly in narrow areas of the face.

### SUMMARY

The present disclosure relates to a beard clipper, more commonly referred to as a “trimmer”, improving visibility and convenience for the user during cutting, by damping the contact between the trimmer and the skin.

More specifically, the trimmer of the present disclosure includes a cutting head offset from the motor, which provides an unobstructed blade assembly and a mechanism for suspending the cutting head, providing a better feel to the user.

The present disclosure is aimed at providing a beard trimmer that does not have the drawbacks of the prior art. The present disclosure is in particular aimed at providing a beard trimmer with improved comfort of use thanks to its ease of handling.

An aim of the present disclosure is to provide a trimmer with an unobstructed cutting head, offering better visibility on the blades on the part of the user during use, compared, in particular, to trimmers of the prior art. In this way, the user has a direct view of the trimming while performing the same. Moreover, the cutting head is as compact as possible, so as to take into account the specific morphological features of the face to be trimmed e.g. the mustache, and the movements of the cutting head easily follow the contours of the face. The handle design is also simplified and more ergonomic.

Another aim is to provide a trimmer with a damping system of the cutting head, improving comfort during the cut. As a result, a better quality of cut is obtained due to the damping system that corrects the differences in pressure exerted on the skin, which may lead to differences in length. Due to the almost constant pressure applied to the skin, the cut is improved. The damping system also helps to limit skin friction and unpleasant sensations related to changes in pressure on the skin.

The present disclosure discloses a beard trimmer with cutting head damping comprising:
a handle comprising a motor;
a cutting head comprising a fixed blade and a movable blade;
a cutting head damping system;
   the damping system comprising:
a movable fixed-blade support connecting the fixed blade of the cutting head to the handle and comprising a proximal portion on the side of the handle of the trimmer and a distal portion on the side of the cutting head, the fixed blade support being pivotably mounted on the handle;
a resilient means creating a return force allowing the movable fixed-blade support to return to its rest position and to dampen the pressure of the cutting head on the user's skin;
   the handle comprising a hollow space for receiving the proximal portion of the movable support, the proximal portion of the movable support being integrally retractable into said hollow space of the handle, when the resilient means is in the rest position.

The particular embodiments of the present disclosure include at least one or any suitable combination of the following features:
the hollow space has substantially the same shape as said proximal portion of the movable support;
the movable support pivots about an axis of rotation perpendicular to the longitudinal axis of the trimmer;
the cutting head is offset from the outlet of the motor by a transmission system;
the distance between the cutting head and the outlet of the motor is comprised between 40 and 70 mm, preferably between 50 and 60 mm;
the transmission system comprises a first ball joint socket located at the outlet of the motor so as to be rotated by the latter, a telescopic transmission shaft comprising two parts, one of which slides in the other, the two ends of said telescopic transmission shaft being in the form of ball joints, the first end being clipped into the first ball joint socket and the second end being clipped into a second ball joint socket, a crank fastened to the second ball joint socket such that, in use, the rotational movement of the first ball joint socket is transmitted to the telescopic transmission shaft and then to the crank via the second ball joint socket, the crank converting the rotational movement transmitted by the second ball joint socket into a translational movement to the movable blade;
the first and second ends of the transmission shaft each comprise two nipples coinciding with two slots located in the first and second ball joint sockets, respectively, to prevent the vertical movement of the first and second ends of the transmission shaft;
the movable fixed-blade support comprises a stop element for retaining said movable fixed-blade support in the handle so that the same does not exceed a predetermined angle of rotation with respect to the trimmer handle;
the stop element is an annular segment, coinciding with a ledge formed inside the handle;
the trimmer comprises a mechanism for locking the cutting unit in one or a plurality of fixed positions;
the resilient means is a spring;
the damping force of the resilient means may vary between 120 and 500 g;
the cutting head is removable for cleaning;
a flexible blade is provided to dampen, in use, the movement of the movable support by means of the contact of the flexible blade with the stop element of the movable support.

### BRIEF DESCRIPTION OF THE DRAWINGS

FIG. 1 shows an example of a beard trimmer according to the present disclosure, in three dimensions and with the cutting head in the rest position, namely when the movable support of the fixed blade is in a retracted position (i.e. when the proximal portion of the support is retracted as far as possible into the handle) and the resilient means (not visible) is not tensioned. It is the pressing action of the trimmer on the skin by the user that exerts pressure on the cutting head, causing the movable support to rotate about its axis. Without pressure, the spring always returns the movable support to its initial rest position. The proximal portion of the support is then aligned with the handle.

FIG. 2 shows an example of a beard trimmer according to the present disclosure, in three dimensions and with the cutting head in the working position, namely when the proximal portion of the movable support protrudes from the handle and the resilient means (not visible) is tensioned. In such case, the user's pressing action on the skin exerts pressure on the cutting head, causing the fixed blade support to rotate about its axis. The proximal portion of the support then forms an angle with the handle.

FIG. 3 shows a longitudinal sectional view of the embodiment shown in FIG. 1.

FIG. 4 shows a longitudinal sectional view of the embodiment shown in FIG. 2.

FIG. 5 is a close-up view of the front portion of the trimmer according to FIG. 3.

FIG. 6 is a close-up view of the front portion of the trimmer according to FIG. 4.

FIG. 7 is a three-dimensional view of FIG. 5.

FIG. 8 is a three-dimensional view of FIG. 6.

FIG. 9 shows a three-dimensional view of the connection between the cutting head and the handle, the transmission system and the resilient means being partially visible.

FIG. 10 shows another three-dimensional view of the connection between the cutting head and the handle, the transmission system and the resilient means being partially visible.

FIG. 11 shows a three-dimensional view of a section wherein the blade spring is illustrated, with the cutting head in the working position.

FIG. 12 shows a three-dimensional view of a section wherein the blade spring is illustrated, with the cutting head in the rest position.

FIG. 13 shows an example of a beard trimmer according to the present disclosure, in three dimensions and with the cutting head in the rest position, the trimmer being seen from above.

### NUMERICAL REFERENCES OF THE FIGURES

1. Beard trimmer
2. Handle
3. Fixed blade
4. Movable blade
5. Cutting head
6. Movable fixed-blade support
7. Motor
8. Resilient means (spring)
9. Rotation axis of the movable support
10. Stop of the movable support
11. Ledge in the handle for the stop
12. Transmission system
13. Proximal portion of the movable support
14. Distal portion of the movable support
15. Crank
16. First ball joint socket
17. Telescopic transmission shaft
18. First end of the transmission shaft (ball joint)
19. Second end of the transmission shaft (ball joint)
20. Second ball joint socket
21. Ball joint nipple
22. Slot in the second ball joint socket
23. Blade spring
24. Hollow in the handle for receiving the proximal portion of the movable support

### DETAILED DESCRIPTION

The present disclosure discloses a beard trimmer 1 comprising a handle 2 and a cutting head 5. The cutting head, as shown in FIG. 5, comprises a set of blades, namely a fixed blade 3 and a movable blade 4. The movable blade is set in motion by means of a motor 7 located in the handle.

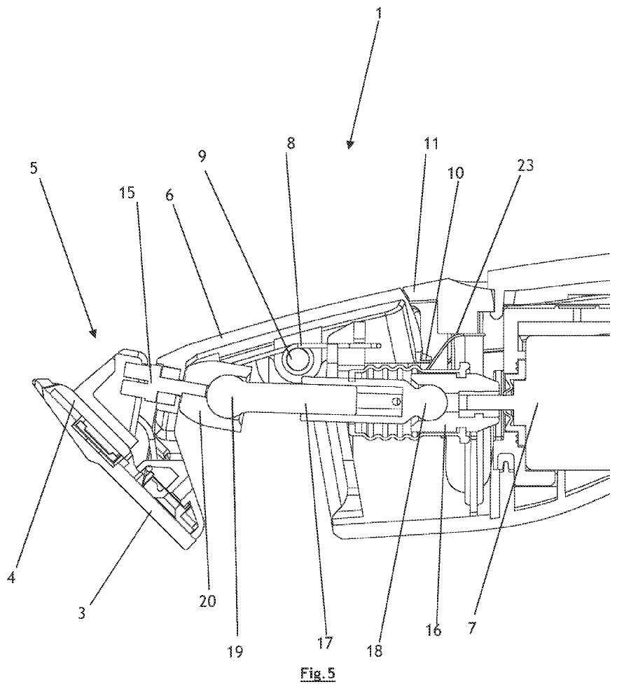

Within the framework of the present disclosure, the trimmer comprises a system for damping the cutting head. The damping system comprises a movable support 6 for the fixed blade which connects the fixed blade of the cutting head to the handle, and a resilient means 8 as illustrated in FIGS. 5 and 6. The movable fixed-blade support is pivotably mounted on the handle, and serves to tilt the cutting head when the user moves the trimmer over their skin. More precisely, the movable support pivots about an axis 9 perpendicular to the longitudinal axis of the handle and the amplitude of the rotation of the movable support varies with the pressure exerted by the skin on the cutting head. The resilient means 8 creates a return force enabling the movable support to return to its equilibrium position and to dampen the pressure of the cutting head on the skin of the user.

More specifically, when the user places the cutting head of the trimmer in contact with the skin, pressure is exerted on the cutting head. The pressure is transmitted to the movable support of the fixed blade, which will pivot about the axis 9, tensioning the resilient means. Depending on the pressure applied by the user on the skin, the movable support will pivot to a variable extent, allowing the fixed blade and hence the entire cutting head to tilt during the trimming of the beard. The damping system henceforth compensates for the movements of the user, which can be too abrupt, jerky or violent. The damping system thus not only softens the movements of the user to provide a better feel, but also to obtain a more uniform cutting length. Indeed, when the user exerts too much pressure on the skin, the blades of the cutting head are closer to the skin, which results in a shorter cutting length. It should be noted that a beard trimmer is difficult to handle due to the different angles of the face and that keeping the same pressure all throughout shaving is not easy for the user.

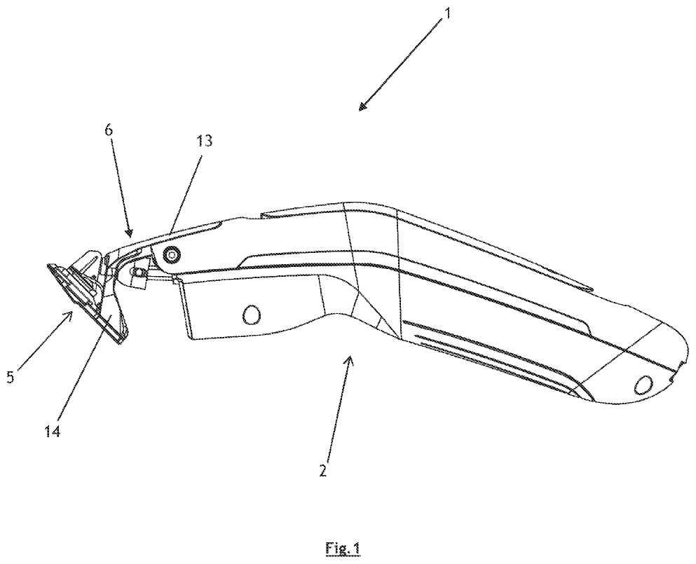

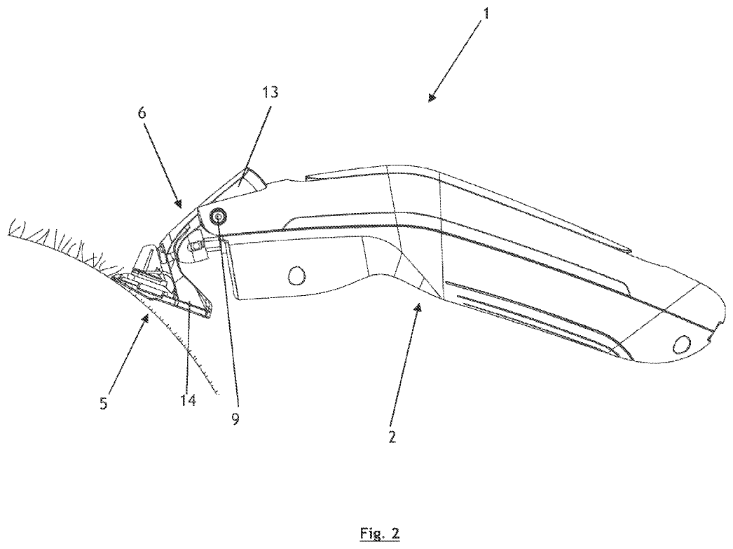

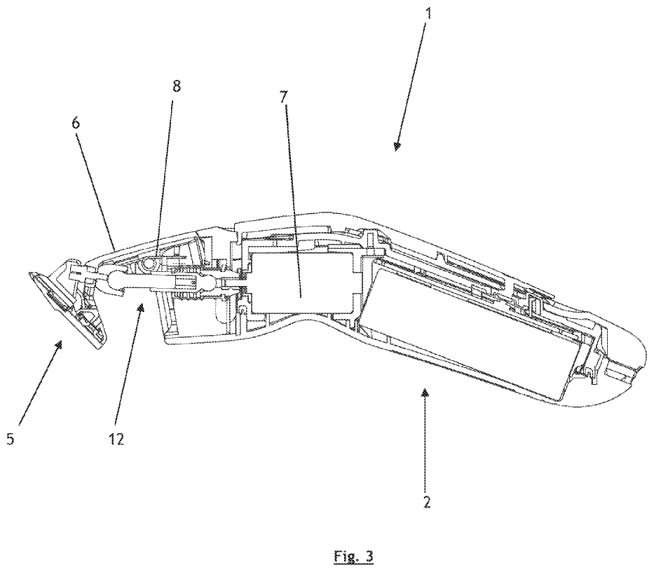

FIG. 3 shows the trimmer with the damping system in the rest position. In such case, the spring is not tensioned, because the cutting head, and hence the movable fixed-blade support, is not under pressure. Without pressure, the spring always returns the movable support to its initial rest position. The movable support comprises a proximal portion 13 located on the side of the handle of the trimmer, and a distal portion 14 located on the side of the head of the trimmer (see FIGS. 1 and 2). When the damping system is in the rest position, the proximal portion of the movable support is retracted as far as possible into the handle, i.e. the proximal portion is aligned with the handle, as illustrated in FIGS. 1, 3, 5 and 7. The handle comprises a hollow space 24 for receiving the proximal portion of the movable support when the damping system is in the rest position. The proximal portion of the movable support is in fact completely retractable into the hollow space, in the rest position. The hollow space has substantially the same shape as the proximal portion. As illustrated in FIG. 13, when the proximal portion is retracted into the handle, the casing of the handle appears to be continuous with the proximal portion of the movable support. The hollow space is preferably located in the upper part of the handle.

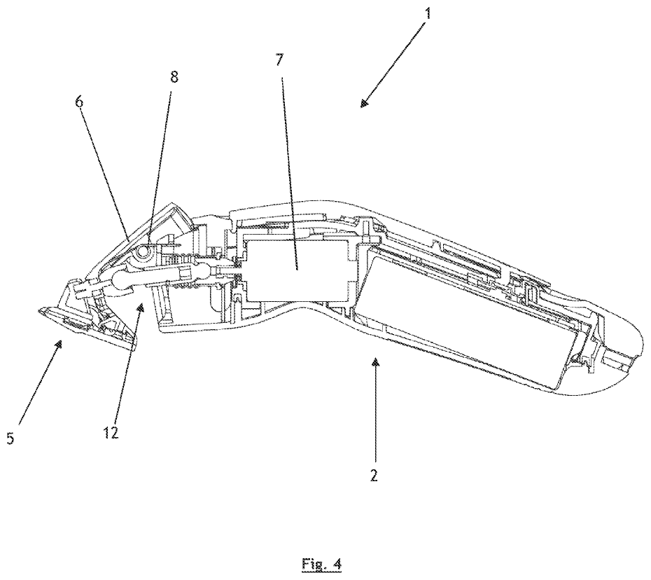

FIG. 4 shows the trimmer with the damping system in the working position. In such case, the spring is tensioned, because the fixed blade of the cutting head, and hence the movable support of the fixed blade, is subjected to pressure in contact with the skin. The spring is tensioned as a result of the rotation of the movable support about its axis. The proximal portion of the movable support protrudes from the handle, forming an angle with the latter, as illustrated in FIGS. 2, 4, 6 and 8.

The trimmer comprises at least one stop element 10 to lock the movable support in a maximum protruded position (see FIG. 6). As illustrated in FIG. 6, the stop element is provided in the form of an abutment on the proximal portion of the movable support, coinciding with a matching ledge 11 provided inside the handle. In this way, the movable support is locked by the stop element abutting against the ledge when the support pivots about its axis, thereby preventing the movable support from leaving completely the handle. The stop element may be in any form, as long as same serves to retain the movable support inside the handle during use (e.g. in the form of an annular stop, or of an annular segment). More precisely, the stop element serves to hold the movable support in the handle, forming a determined angle of rotation between the proximal portion thereof and the handle. The angle may be comprised between 10 and 40 degrees, preferably between 20 and 30 degrees.

The purpose of the beard trimmer according to the present disclosure is also to provide the user with a device having an unobstructed cutting head allowing better visibility on the blades and giving the user a direct view of the trimming when performing same. To achieve such goal, the inventor has considerably modified the transmission system of the transmission shaft with a moving blade of conventional trimmers. The specific transmission system 12 of the trimmer of the present disclosure causes the cutting head to be offset from the outlet of the motor by a distance comprised between 40 and 70 mm, preferably between 50 and 60 mm. Such modification of the transmission system makes it possible to respond to the rotational movements of the movable support and to tilting movements of the cutting head. The cutting head is thus freed up by moving same away from the outlet of the motor. The space taken up around the cutting head is thereby limited, making it possible to trim the narrowest areas of the face and at the same time providing greater freedom of movement.

The transmission system comprises a set of elements for transmitting and converting the rotational movement generated by the motor into a translational movement to the movable blade, so as to create the back-and-forth movement of the movable blade relative to the fixed blade. In general, in the trimmers of the prior art, the rotational movement at the outlet of the motor is transmitted to a crank, which directly converts the rotation into translation to the moving blade, by means of its off-center axis, which converts the circular movement into lateral movement. In the present disclosure, a crank 15 is also present in the trimmer, directly in contact with the movable blade to convert the movement of the motor, but the crank is offset with respect to the outlet of the motor. A plurality of elements are comprised between the outlet of the motor and the crank so as to allow the cutting head to tilt freely following the rotation of the movable support. As illustrated in FIGS. 5 and 6, a first ball joint socket 16 is located at the outlet of the motor to be rotated by the latter. A telescopic transmission shaft 17 has a first end 18 connected to the first ball joint socket, and a second end 19 connected to a second ball joint socket 20. The two ends 18 and 19 of the shaft are in the form of ball joints and are clipped into the first and second ball joint sockets which have a hollow shape coinciding with the ends of the shaft. In this way, the rotational movement of the first ball joint socket is transmitted to the telescopic transmission shaft, which can then be transmitted to the crank 15 being connected to the second ball joint socket 20. The crank converts the rotational movement transmitted by the second ball joint socket into a translational movement to the movable blade, by means of its off-center axis enabling the circular movement to be converted into a lateral movement.

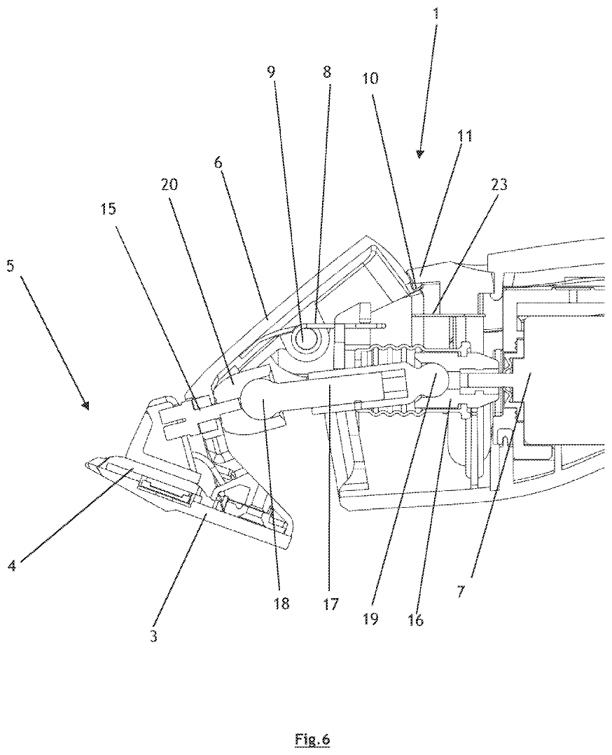

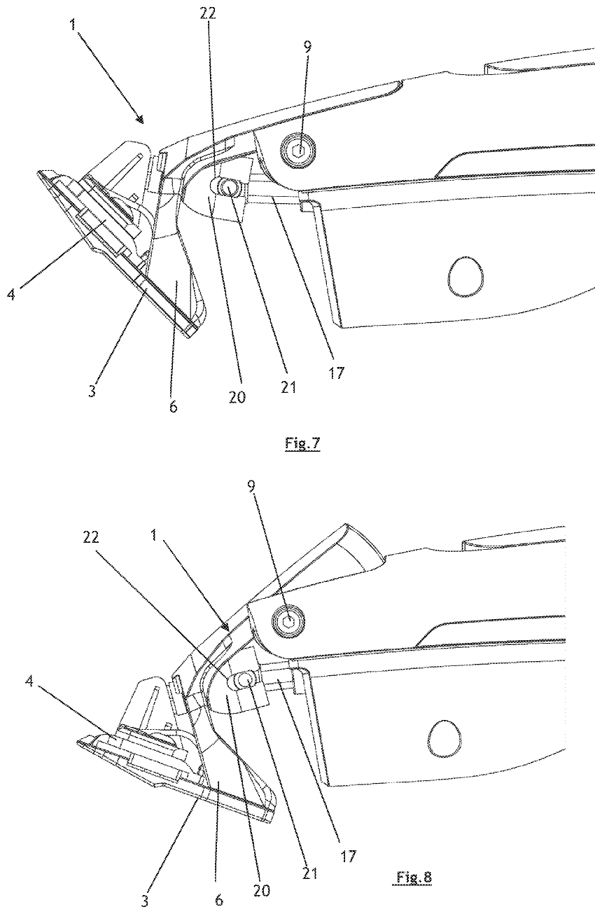

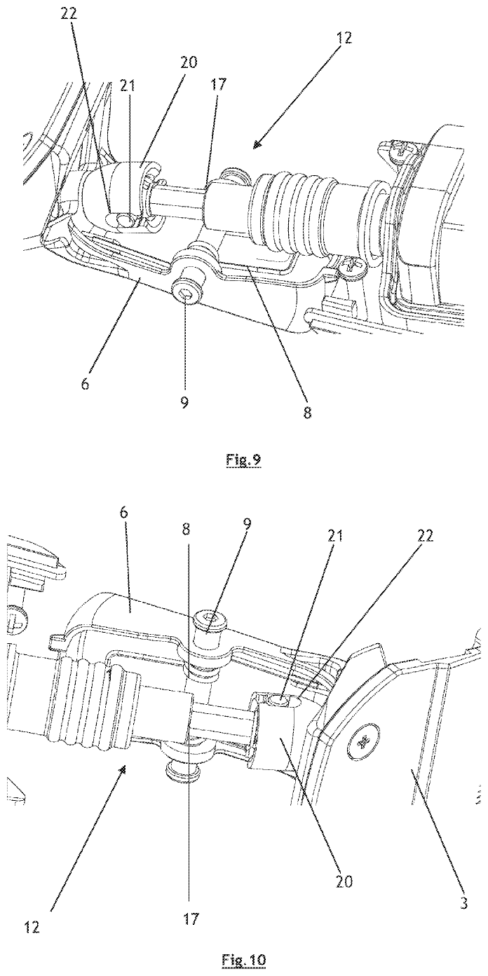

The transmission shaft comprises two parts sliding inside one another to perform a translational movement, such movement being created during the damping movements of the cutting head. Moreover, the first and second ends of the transmission shaft in the form of ball joints have a mechanism preventing same from performing vertical movement, only lateral and rotational movements being permitted thereto. Indeed, as illustrated in FIGS. 7 to 10, the first and second ball joint sockets comprise two diametrically opposite slots 22, allowing the ball joint to be locked in the vertical direction by means of two nipples 21 located on both sides of each of the ball joints, coinciding with the slots (the slot and nipple locking mechanism is shown for the second socket, but the mechanism is the same on the first socket).

The cleaning of the cutting head is also facilitated by the fact that the cutting head is further away from the handle. The head can thus be placed more easily under running water without getting the rest of the trimmer wet. However, it is preferable for the cutting head to be removable, so as to be detached from the rest of the trimmer for more effective cleaning.

According to the present disclosure, the trimmer may also comprise a means for adjusting the damping force of the resilient means 8 (not shown). The adjusting means could be operated by the user to choose the damping force that is best suited to the type of beard trimming they perform. Setting a strong damping force will increase the force needed to dampen skin contact; setting a low damping force will make the trimmer much more sensitive to pressure. The damping force of the resilient means may vary between 120 and 500 g.

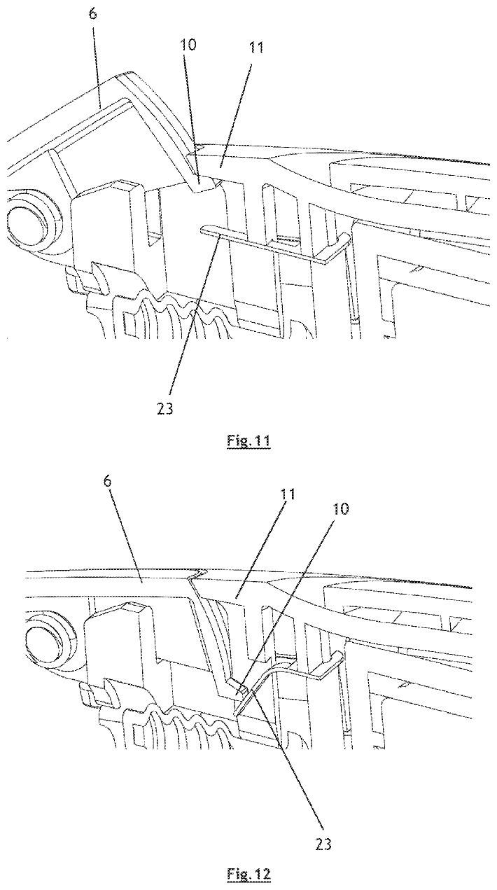

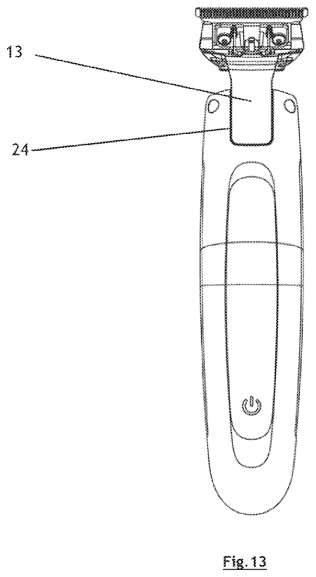

The trimmer of the present disclosure may also comprise a system for slowing down the switching of the movable support from the working position to its initial rest position. Indeed, the movable support can pivot abruptly when the trimmer is removed from the skin, and thus when there is no contact with or pressure on the fixed blade. When the user removes the trimmer, pressure is no longer applied on the blade, and the movable support is returned to its initial position by the resilient means. However, the return movement to the rest position might be done too abruptly, causing the cutting head to be lifted abruptly as well, which may surprise or strike the user in narrow areas. To dampen the return of the blades, a flexible blade or blade spring 23 (see FIGS. 5, 6, 11 and 12) can be provided at the stop 10. It is a very thin metal blade, with a lower force compared to the resilient means. When the movable support moves from its rest position to its working position, the stop has no contact with the blade spring. Conversely, when the movable support switches from its working position to its rest position, the stop comes into friction with the blade of the blade spring. The metal blade has a certain flexibility serving to dampen the movement of the movable support.

According to another aspect of the present disclosure, the trimmer is equipped with a mechanism for locking the cutting head in at least one fixed position. The user can thereby lock the cutting head at a certain distance from the handle if they wish to temporarily stop using the damping function of the trimmer.

The trimmer of the present disclosure may also include a rechargeable battery. This way the trimmer can be used without a power cable. The trimmer can also be designed to operate only on the mains with a power cable or can be designed with a combination of the two power modes (mains or battery).

1. A beard trimmer with cutting head damping, the beard trimmer comprising:
a handle comprising a motor;
a cutting head comprising a fixed blade and a movable blade; and
a cutting head damping system;
the damping system comprising:
a movable fixed-blade support connecting the fixed blade of the cutting head to the handle and comprising a proximal portion on a side of the handle of the trimmer and a distal portion on a side of the cutting head, the movable fixed-blade support being pivotably mounted on the handle;
a spring configured to create a return force allowing the movable fixed-blade support to return to a rest position and to dampen a pressure of the cutting head on a user's skin;
wherein the handle comprises a hollow space configured to receive the proximal portion of the movable support, the proximal portion of the movable support being integrally retractable into said hollow space of the handle when the spring is in the rest position.

2. The beard trimmer according to claim 1, wherein the hollow space has substantially the same shape as said proximal portion of the movable support.

3. The beard trimmer according to claim 1, wherein the movable support pivots about an axis of rotation perpendicular to a longitudinal axis of the trimmer.

4. The beard trimmer according to claim 1, wherein the cutting head is offset from an outlet of the motor by a transmission system.

5. The beard trimmer according to claim 4, wherein a distance between the cutting head and the outlet of the motor is comprised between 40 and 70 mm.

6. The beard trimmer according to claim 4 wherein the transmission system comprises:
a first ball joint socket located at the outlet of the motor, wherein the first ball joint socket is configured to be rotated by the motor;
a telescopic transmission shaft comprising two parts, one of which slides into the other, first and second ends of said telescopic transmission shaft being in the form of ball joints, the first end being clipped into the first ball joint socket and the second end being clipped into a second ball joint socket;
a crank fastened to the second ball joint socket;
such that, in use, a rotational movement of the first ball joint socket is transmitted to the telescopic transmission shaft and then to the crank via the second ball joint socket, the crank converting the rotational movement transmitted by the second ball joint socket into a translational movement to the movable blade.

7. The beard trimmer according to claim 6, wherein the first and second ends of the transmission shaft each comprise two nipples coinciding with two slots located in the first ball joint socket and the second ball joint socket, respectively, to prevent the vertical movement of the first and second ends of the transmission shaft.

8. The beard trimmer according to claim 1, wherein the movable fixed-blade support comprises a stop element configured to retain said movable fixed-blade support in the handle such that the fixed-blade support does not exceed a predetermined angle of rotation with respect to the handle of the trimmer.

9. The beard trimmer according to claim 8, wherein the stop element is an annular segment, coinciding with a ledge formed inside the handle.

10. The beard trimmer according to claim 1, wherein the fixed blade is configured to be selectively locked in one of a plurality of fixed positions.

11. The beard trimmer according to claim 1, wherein the spring comprises a torsion spring.

12. The beard trimmer according to claim 1, wherein the damping force of the spring is variable between 120 and 500 g.

13. The beard trimmer according to claim 1, wherein the cutting head is removable for cleaning.

14. The beard trimmer according to claim 1, further comprising a flexible blade configured to dampen, in use, the movement of the movable support by the flexible blade contacting the stop element of the movable support.
